(19) United States
(12) Patent Application Publication
(10) Pub. No.: US 2020/0394249 A1
(43) Pub. Date: Dec. 17, 2020

(54) EFFICIENT DATA PROPAGATION IN A COMPUTER NETWORK

(71) Applicant: SIEMENS AKTIENGESELLSCHAFT, München (DE)

(72) Inventors: Regine Meunier, München (DE); Tobias Emrich, München (DE); Christian Frey, Stadtbergen (DE); Matthias Renz, Fairfax, VA (US); Andreas Zuefle, Fairfax, VA (US)

(21) Appl. No.: 16/463,934

(22) PCT Filed: Nov. 25, 2016
(86) PCT No.: PCT/EP2016/078850

§ 371 Date: May 24, 2019

(51) Int. Cl. G06F 17/10; G06N 7/00

(52) U.S. Cl. CPC G06F 17/10; G06N 7/005

(57) ABSTRACT

Propagating data in a technical network by considering runtime requirements. A component tree data structure is generated for a probabilistic graph representing the technical network and its technical constraints. On the component tree a propagation algorithm is applied, which iteratively determines an optimal edge in the generated component tree, which maximizes an expected information flow to a query node to and/or from each network node by considering the technical network constraints and by executing a Monte-Carlo sampling for estimation of the expected information flow for the cyclic components and by computing the expected information flow of the non-cyclic components analytically and which updates the component tree iteratively with each determined optimal edge and re-estimates the expected information flow in the updated component tree for providing a result with nodes in the technical network for data propagation, so that information flow is maximized by considering technical network constraints.

### CROSS-REFERENCE TO RELATED APPLICATIONS

This application claims priority to PCT Application No. PCT/EP2016/078850, having a filing date of Nov. 25, 2016, the entire contents of which is hereby incorporated by reference.

### FIELD OF TECHNOLOGY

The present embodiment of the invention refers to reliable propagation of data packets or messages in large networks, for example, communication networks.

### BACKGROUND

Nowadays, technical telecommunication or electrical networks have become ubiquitous in our daily life to receive and share information. Whenever we are navigating the World Wide Web or sending a text message on our cell-phone, we participate in an information network as a node. In such networks, network nodes exchange some sort of information: In wireless sensor networks nodes collect data and aim to ensure that this data is propagated through the network: Either to a destination, such as a server node, or simply to as many other nodes as possible. Abstractly speaking, in all of these networks, nodes aim at propagating their information throughout the network. The event of a successful propagation of information between nodes is subject to inherent uncertainty.

In a wireless sensor, telecommunication or electrical network, a link can be unreliable and may fail with certain probability. The probabilistic graph model is commonly used to address such scenarios in a unified way. In this model, each edge is associated with an existential probability to quantify the likelihood that this edge exists in the graph. Traditionally, to maximize the likelihood of a successful communication between two nodes, information is propagated by flooding it through the network. Thus, every node that receives a bit of information will proceed to share this information with all its neighbors. Clearly, such a flooding approach is not applicable for large communication networks as the communication between two network nodes incurs a cost: Sensor network nodes, e.g. in micro-sensor networks, have limited computing capability, memory resources and power supply, require battery power to send, receive and forward messages, and are also limited by their bandwidth.

In this embodiment the following problem is addressed. Given a probabilistic network graph G with edges that can be activated for communication, i.e. enabled to transfer information, or stay inactive. The problem is to send/receive information from a single node Q in G to/from as many nodes in G as possible assuming a limited budget of edges that can be activated. To solve this problem, the main focus is on the selection of edges to be activated.

In state of the art mining probabilistic graphs (a.k.a. uncertain graphs) is known and has recently attracted much attention in the data mining and database research communities, for example in: A. Khan, F. Bonchi, A. Gionis, and F. Gullo. Fast reliability search in uncertain graphs. In EDBT, pages 535-546, 2014.

Subgraph Reliability. A related and fundamental problem in uncertain graph mining is the so-called subgraph reliability problem, which asks to estimate the probability that two given (sets of) nodes are reachable. This problem, well studied in the context of communication networks, has seen a recent revival in the database community due to the need for scalable solutions for big networks. Specific problem formulations in this class ask to measure the probability that two specific nodes are connected (so called two-terminal reliability), all nodes in the network are pairwise connected (all-terminal reliability), or all nodes in a given subset are pairwise connected (k-terminal reliability). Extending these reliability queries, where source and sink node(s) are specified, the corresponding graph mining problem is to find, for a given probabilistic graph, the set of most reliable k-terminal subgraphs. All these problem definitions have in common that the set of nodes to be reached is predefined, and that there is no degree of freedom in the number of activate edges—thus all nodes are assumed to attempt to communicate to all their neighbors, which we argue can be overly expensive in many applications.

Reliability Bounds. Several lower bounds on (two-terminal) reliability have been defined in the context of communication networks. Such bounds could be used in the place of our sampling approach, to estimate the information gain obtained by adding a network edge to the current active set. However, for all these bounds, the computational complexity to obtain these bounds is at least quadratic in the number of network nodes, making these bounds unfeasible for large networks. Very simple but efficient bounds have been presented, such as using the most-probable path between two nodes as a lower bound of their two-terminal reliability. However, the number of possible (noncircular) paths is exponentially large in the number of edges of a graph, such that, in practice, even the most probable path will have a negligible probability, thus yielding a useless upper bound. Thus, since none of these probability bounds are sufficiently effective and efficient for practical use, we directly decided to use a sampling approach for parts of the graph where no exact inference is possible.

Reliable Paths. In mobile ad-hoc networks, the uncertainty of an edge can be interpreted as the connectivity between two nodes. Thus, an important problem in this field is to maximize the probability that two nodes are connected for a constrained budget of edges. The main difference of prior art relating to ad-hoc networks to the present application is that the information flow to a single destination is maximized, rather than the information flow in general. The heuristics cannot be applied directly to the pending problem, since clearly, maximizing the flow to one node may detriment the flow to another node.

### SUMMARY

Therefore, an aspect relates to improving data propagation in networks in an efficient way. Moreover, such a data propagation algorithm should provide the option to handle a trade-off between a high efficiency (but low information flow) and high information flow (but exponential runtime for computing the information flow). Thus, runtime requirements should be considered by computing a data propagation result. Further, circular and non-circular network paths should be processable and taken into account.

Another aspect relates to a method for reliably optimizing data propagation in a technical network with a plurality of nodes and edges by processing technical network constraints for activating said connection (edge) in the technical network, wherein the technical network is represented as a probabilistic graph with edges representing probability values, comprising the following steps:
Generating a component tree as data structure for the technical network by partitioning the probabilistic graph into independent components, representing a subset of the probabilistic graph and comprising cyclic and non-cyclic components, wherein an edge in the component tree represents a parent-child relationship between the components
Iteratively determining an optimal edge in the probabilistic graph, which maximizes an expected information flow to a query node to and/or from each node by processing the technical network constraints and by
   Executing a Monte-Carlo sampling for estimation of the expected information flow for the cyclic components and
   Computing the expected information flow of the non-cyclic components analytically
Updating the component tree iteratively with each determined optimal edge and re-estimating the expected information flow in the updated component tree
Calculating an optimal set of edges and based thereon providing a result with nodes in the technical network for data propagation, so that information flow is maximized by taking into account the technical network constraints and runtime requirements so that predetei mined runtime requirements are met.

In the following a short definition of terms is given.

Optimizing data propagation refers to finding network connections for distributing information or data to and/or from a query node to a plurality of network nodes. “Optimizing” in this respect refers to the maximization of information flow. It, thus, aims at not necessarily reaching all network nodes, but at reaching as many nodes as possible under cost constraints. Optimizing refers taking the uncertainty of network connections (links) into account and activating (only) those connections (edges) within the network that maximize the probability of communication between nodes in general and, accordingly, the flow of information. Cyclic structures in the network are possible and are taken into account for data propagation and optimization thereof.

The present approach is an overall approach, taking into account interdependencies of the network nodes. State of the art heuristics cannot be applied directly to the pending problem, since maximizing the flow to one node may detriment the flow to another node. In this embodiment of the invention and application mutual interdependencies are considered as well for information propagation in a network.

The optimization is executed in a reliable manner. This refers to the context of an all-terminal reliability, with a limited budget of edges which may be activated for propagating information or data through the network. All or selected nodes of the network may be activated for data propagation. In general, edges in the technical network can be activated (used) for communication, i.e. enabled to transfer information, or stay inactive (unused).

The technical network is represented in a probabilistic graph, wherein the edges in the probabilistic graph are assigned with probability values, representing the network constraints or a budget of limited technical transfer capabilities. The edges may be assigned probabilities for a certain failure rate or loss rate. For example, in a sensor network, some micro-sensors may have limited computing capabilities and may incur network costs if they should be activated for sending or receiving data. Other nodes may only be connected to the network via a network connection with low bandwidth, so that performance impacts have to be considered when activating that node. In general, an edge may be activated. The availability of the corresponding node therefore implicitly results from the activation of the edge, which has the node as leaf structure or end point.

The component tree is a data structure for storing propagation and network information relating to the technical network. The technical network may be represented in a probabilistic graph with nodes and edges, wherein the nodes represent entities (i.e. hardware entities, like servers) and the edges represent links or connections between these entities. If the connections are assigned reliabilities, these reliabilities are represented as probabilities on the edges. The component tree representation of the graph (representing the technical network) has the technical effect that an algorithm is capable to compute the information flow from a certain single node Q in the graph G to/from as many nodes in the graph as possible as efficient as possible (relating to runtime) and assuming a limited budget of edges that can be activated due to technical network constraints. According to the embodiments of the invention, basic algorithms and optimization extensions thereof are provided for computing a selection of edges to be activated. A component tree representation is a spanning tree from a topology point of view. However, the difference to a “normal” spanning tree is, that instead storing nodes, components are stored in the component tree structure. Each component comprises a subset of nodes of the set of all nodes. For all nodes of the subset their corresponding reachability within the component is stored. In particular, their reachability is stored in the component tree structure.

According to an aspect of the embodiment of the invention this probabilistic graph is partitioned into independent components, which are indexed using a component tree index structure called component tree. A component is a set of nodes (vertices) together with a hub vertex that all information must flow through in order to reach a certain network node Q for which the expected information flow should be computed. These components are then structured in the component tree structure by considering a parent-child relationship between the independent components. A component C is child of a component P, if the information flow of component P has to be transferred via component C. Thus, an edge in the component tree represents the parent-child relationship between the respective components.

The present embodiment of the invention refers to data propagation in a reliable way. Generally, the term “Reliability” concerns the ability of a network to carry out a desired operation such as “communication”. In case all operative nodes are communicating, the reliability measure is called “All terminal Reliability” or “Network Reliability”. In the context of graph theory, present embodiment of the invention refers to so called “terminal reliability”. Terminal reliability refers to the probability for finding a path or reaching all terminal nodes from a specific source node.

The technical network constraints are a set of parameter values for network issues. They may be configured in a configuration phase of the method. The constraints may for example refer to limited computing capabilities, limited memory resources and power supply, limited battery power to send, receive and/or forward messages or data and last but not least to limited bandwidth and/or to limited accessibility or availability of a node. The technical network constraints may refer to a network or communication budget. The budget usually is constrained (in practice). The budget constraint is due to the communication cost between two or more nodes. In technical applications, for example streaming data from sensor network nodes or monitoring and controlling renewables decentrally, it is important to maximize the information flow under budget constraints. An optimization algorithm is necessary in order to handle the trade-off between high efficiency (fast runtime, but lower information flow) and high information flow (low efficiency, long runtime, but optimized solution). The limited budget or the network constraints have to be taken into account for data propagation in the network. Generally, it is not necessary that all network nodes are reached but it is important that as many as possible nodes are reached under cost constraints. The present embodiment of the invention provides an automatic solution for this problem. According to an aspect of the present embodiment of the invention the network constraints may change dynamically over time and this change is also processing for calculation of the result by executing re-calculations and providing updates of the component tree structure.

Runtime requirements may be represented in a runtime parameter, which may be configured in a configuration phase of the method. The runtime requirements may be categorized in classes, for example low, middle or exponential runtime. Based on the determined runtime requirements an appropriate edge selection algorithm will be selected for execution, for example a basic component tree based algorithm or a memorization algorithm, a confidence interval based sampling or a delayed sampling algorithm.

The network is a technical network. The network may be a telecommunication network, an electric network and/or a WSN network (WSN: wireless sensor technology), which comprise spatially distributed autonomous sensors to monitor physical or environmental conditions, such as temperature, pressure, etc. and to cooperatively pass their data through the network to a certain network location or query node. The topology of these networks can vary from a simple star network to an advanced multi-hop wireless mesh network. The propagation technique between the hops of the network is controlled by the optimization method according to the embodiment of the invention.

The result is a list of network edges, which when activated will have an optimized information flow while simultaneously complying with the technical network constraints and by meeting the runtime requirements. The result may be provided by minimizing runtime. Accordingly, the nodes are implicit given by the edges.

Updating the component tree refers to iteratively adding an edge to the independent component tree, which has been calculated as being optimal in a previous step and storing the same in the updated version of the component tree and re-estimating the expected information flow in the updated version.

According to a preferred embodiment of the present invention iterative determination of an optimal edge is executed by applying a heuristic, exploiting features of the component tree. This has the technical effect that the handling of the trade-off between efficiency (runtime fast or slow) and effectiveness (low or high information flow) of the algorithm may be controlled and balanced according to actual system requirements.

According to another preferred embodiment of the present invention the heuristic is based on a Greedy algorithm. The probabilistic graph serves as input of the algorithm for optimizing data propagation in the technical network.

The probabilistic graph has a source node Q, which may be defined by the user. At the beginning of the algorithm and in the first iteration the component tree representation is empty, because there is no information available about which edges are to be activated. In each iteration step, just one edge, namely the edge, which has been calculated as being optimal, is activated and is stored in the updated component tree representation. Thus, in each iteration a set of candidate edges is maintained. For this reason, each edge in the set of candidate edges is probed by calculating the information flow under the assumption that the edge would be added to the component tree. After all iterations, the edge with the highest information flow can just be selected. This is possible, because the candidate list is ordered within a heap, i.e. the one with the highest information flow is on top of the heap. It is not necessary to compute the edge with maximal gain in information flow. This has a major technical effect in that perfoiniance may be improved significantly.

According to another preferred embodiment of the present invention iteratively determining the optimal edge is optimized by component memorization:
skipping the step of executing a Monte-Carlo sampling for estimation of the expected information flow of the cyclic components which remained unchanged and by
memorizing and re-using calculated values of the information flow for the unchanged components.

According to another preferred embodiment of the present invention the Monte-Carlo sampling is optimized by pruning the sampling and by sampling confidence intervals, so that probing an edge is stopped whenever another edge has a higher information flow with a certain degree of confidence.

According to another preferred embodiment of the present invention the Monte-Carlo sampling is optimized by application of a delayed sampling, which considers the costs for sampling a candidate edge in relation to its information gain in order to minimize the amount of candidate edges to be sampled.

According to another preferred embodiment of the present invention providing the result is optimized with respect to runtime. For this reason, it is possible to determine runtime requirements, for instance by reading in the requirements via an input interface of a control node. Then, that edge selection algorithm may be selected (for application) which conforms with the determined runtime requirements. This has the technical effect that it is possible to balance and to dynamically adapt the ratio between effectiveness (short runtime, but with a low information flow) and efficiency (long runtime, but high information flow).

According to another preferred embodiment of the present invention the number of edges in the technical network, which can be activated, is limited due to the technical network constraints or a limited budget of edges that can be activated.

According to another preferred embodiment of the present invention computing the expected information flow of the non-cyclic components analytically is based on the following equation (equation (2)):

$$E ( ( {\sum }_{v ∈ V} ( Q , v , G ) ) \cdot W ( v ) ) = {\sum }_{v ∈ V} E ( ( Q , v , G ) ) \cdot W ( v )$$

wherein G=(V, E, W, P) is a probabilistic directed graph, where V is a set of vertices v, E ⊆V×V is a set of edges, W: V→ [symbol] ⁺ is a function that maps each vertex to a positive value representing the information weight of the corresponding vertex and wherein Q∈V is a node.

According to another preferred embodiment of the present invention determining an optimal edge is executed by selecting a locally most promising edge out of a set of candidate edges, for which the expected information flow can be maximized, wherein the estimation of the expected information flow for a candidate edge is executed only on those components of the component tree which are affected, if the candidate edge would be included in the component tree representation of the technical network.

According to another preferred embodiment of the present invention the method further comprises the step of:
Aggregating independent subgraphs of the probabilistic graph efficiently, while exploiting a sampling solution for components of the graph MaxFlow(G, Q, k) that contain cycles.

Another aspect of the present embodiment of the invention refers to a computer network system with a plurality of nodes and connections between the nodes, which is represented in a probabilistic graph, wherein an edge of the graph is assigned with a probability value, representing a respective technical network constraint for activating said edge in the network, comprising:
A control node, which is adapted to control the propagation of data in the network by executing a method as mentioned above.

Another aspect of the present embodiment of the invention refers to a control node in a computer network system with a plurality of nodes and connections between the nodes, which is represented in a probabilistic graph, wherein an edge of the graph is assigned with a probability value, representing a respective technical network constraint for activating said edge in the network, wherein the control node is adapted to control the propagation of data in the network by executing a method as mentioned above.

According to a preferred embodiment, the control node may be implemented on a sending node for sending data to a plurality of network nodes.

According to another preferred embodiment, the control node is implemented on a receiving node for receiving data from a plurality of network nodes, comprising sensor nodes.

The control node may be a dedicated server node for optimizing data propagation in the technical network. However, the control node may also be implemented on any of the network nodes by installation of a computer algorithm for executing the method mentioned above.

### BRIEF DESCRIPTION

Some of the embodiments will be described in detail, with reference to the following figures, wherein like designations denote like members, wherein:

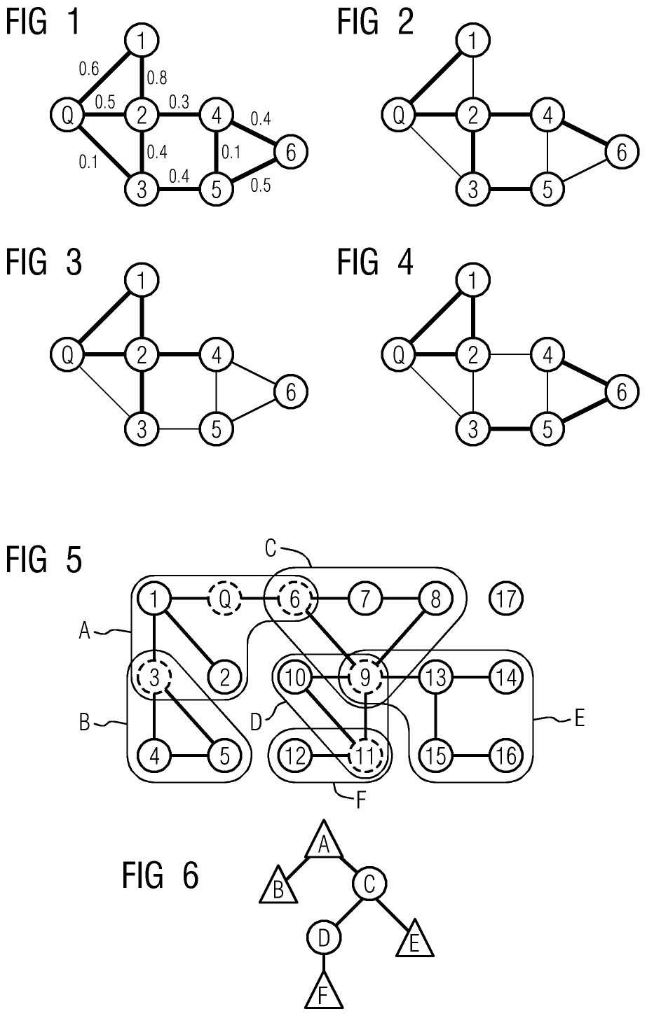

FIG. 1 depicts an original graph in a schematic form exemplarily illustrating a technical network;

FIG. 2 depicts a maximum spanning tree according to the Dijkstra algorithm in a schematic form;

FIG. 3 depicts an optimal five edge flow in a schematic form;

FIG. 4 depicts a possible world g1 in a schematic form;

FIG. 5 schematically illustrates an example graph with information flow to source node Q according to an embodiment of the invention and

FIG. 6 schematically illustrates the component tree representation of the graph according to FIG. 5 by way of example;

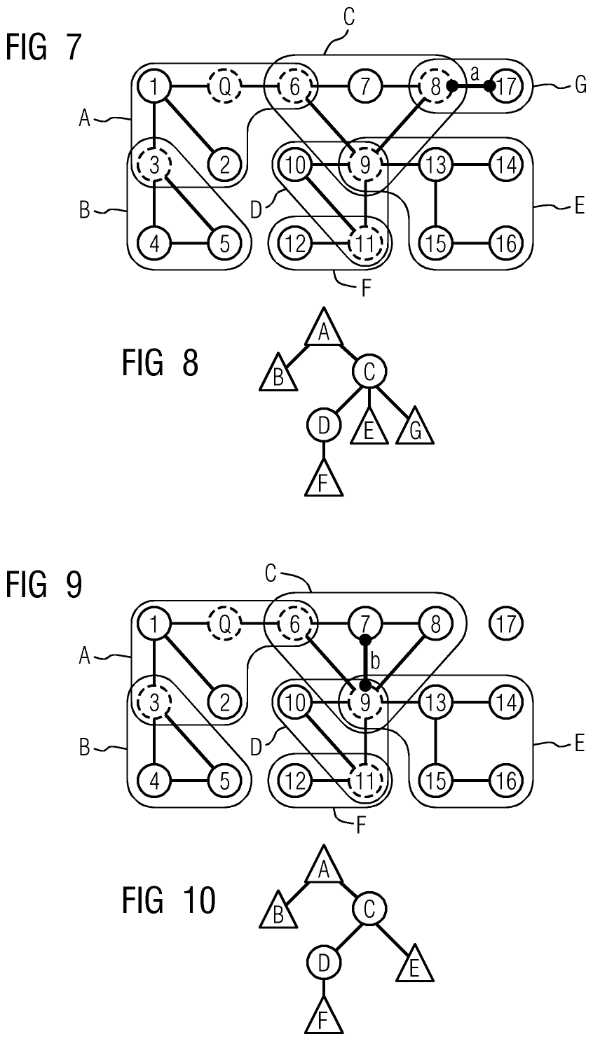

FIG. 7 schematically illustrates an example of edge insertion and the update of the component tree, based on the example of FIGS. 5 and 6, illustrating insertion of edge a;

FIG. 8 schematically illustrates an example of edge insertion and the update of the component tree, based on the example of FIGS. 5 and 6, showing the update of the component tree after insertion of the edge a, depicted in FIG. 7;

FIG. 9 schematically illustrates an example of edge insertion and the update of the component tree, based on the example of FIGS. 5 and 6, illustrating insertion of edge b;

FIG. 10 schematically illustrates an example of edge insertion and the update of the component tree, based on the example of FIGS. 5 and 6, showing the update of the component tree after insertion of the edge b, depicted in FIG. 9;

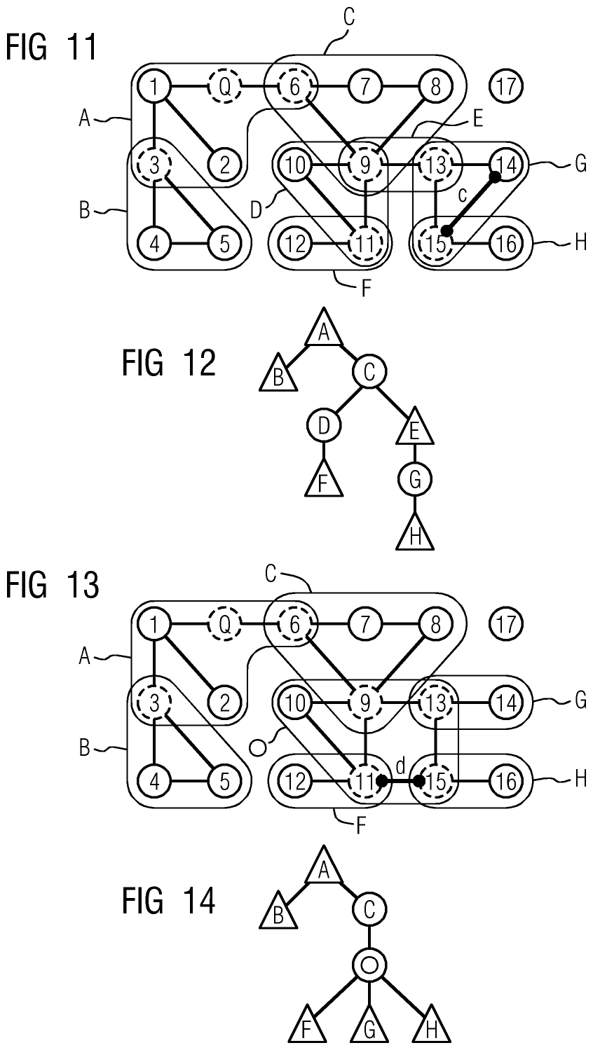

FIG. 11 schematically illustrates an example of edge insertion and the update of the component tree, based on the example of FIGS. 5 and 6, illustrating insertion of edge c;

FIG. 12 schematically illustrates an example of edge insertion and the update of the component tree, based on the example of FIGS. 5 and 6, showing the update of the component tree after insertion of the edge c, depicted in FIG. 11;

FIG. 13 schematically illustrates an example of edge insertion and the update of the component tree, based on the example of FIGS. 5 and 6, illustrating insertion of edge d;

FIG. 14 schematically illustrates an example of edge insertion and the update of the component tree, based on the example of FIGS. 5 and 6, showing the update of the component tree after insertion of the edge d, depicted in FIG. 13;

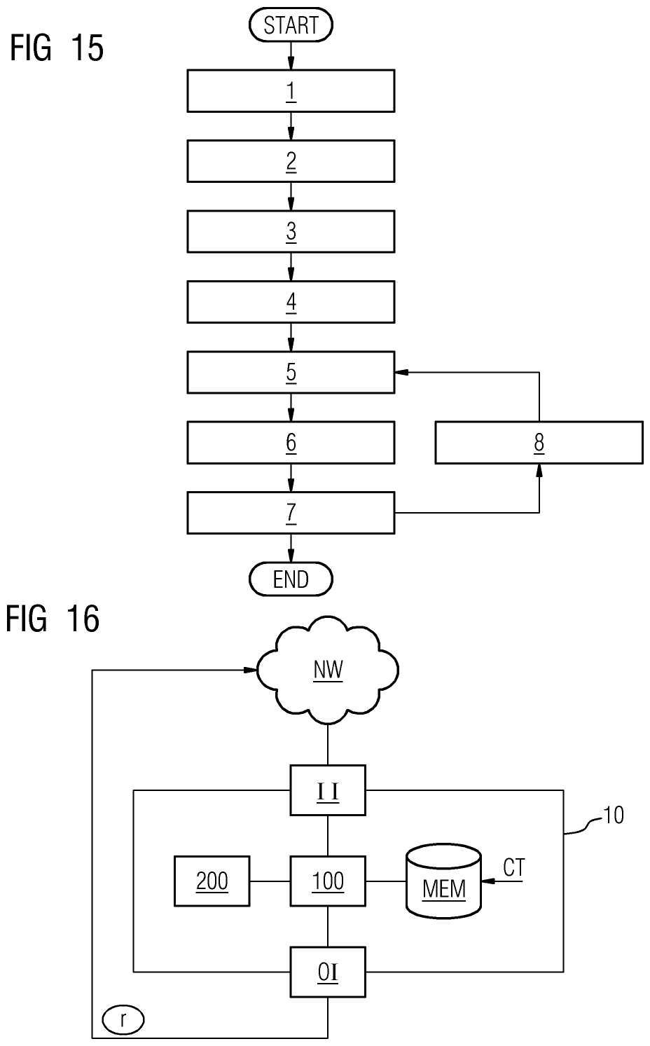

FIG. 15 depicts a flow chart for executing a method for optimizing data propagation in the technical network according to an embodiment of the present invention; and

FIG. 16 depicts a block diagram in schematic format showing a control node for optimizing data propagation within the network.

### DETAILED DESCRIPTION

In the following description, for purposes of explanation and not limitation, specific details are set forth, such as particular network environments and communication standards etc., in order to provide a thorough understanding of the current embodiment of the invention. It will be apparent to one skilled in the art that the current embodiment of the invention may be practiced in other embodiments that depart from these specific details. For example, the skilled artisan will appreciate that the current embodiment of the invention may be practiced with any wireless network like for example UMTS, GSM or LTE networks. As another example, the embodiment of the invention may also be implemented in wireline networks, for example in any IP-based networks. Further the invention is applicable for implementing in any data center deploying usage data propagation mechanisms and data routing. In particular, the embodiment of the invention may be applied to the technical administration or management of a cloud computing network.

In order to illustrate the general problem setting, reference is made to FIG. 1. Consider the network depicted in FIG. 1, where the task is to maximize the information flow from node Q to other nodes given a limited budget of edges to be used. In contrast to the general problem defined later, this example assumes equal weights of all nodes. Each edge of the network is labeled with a probability value denoting the probability of a successful communication. A straightforward solution to this problem, is to activate all edges. Assuming each node to have one unit of information, the expected information flow of this solution can be shown to be ≈2.51. While maximizing the information flow, this solution incurs the maximum possible communication cost. A traditional trade-off between these single-objective solutions is using a probability maximizing Dijkstra spanning tree, as depicted in FIG. 2. The expected information flow in this setting can be shown to aggregate to 1.59 units, while requiring six edges to be activated. Yet, it can be shown that the solution depicted in FIG. 3 dominates this solution: Only five edges are used, thus further reducing the communication cost, while achieving a higher expected information flow of ≈2.02 units of information to Q.

The aim of the method according to the embodiment of the invention is to efficiently find a near-optimal subnetwork, which maximizes the expected flow of information at a constrained budget of edges. In the example, mentioned above with respect to FIG. 1, the information flow for various example graphs was computed. But in fact, this computation has been shown to be # P hard in the number of edges of the graph, and thus impractical to be solved analytically. Furthermore, the optimal selection of edges to maximize the information flow is shown to be np-hard. These two subproblems define the main computational challenges addressed and solved with this algorithm.

### Problem Definition

A probabilistic directed graph is given by G=(V, E, W, P), where V is a set of vertices, E ⊆V×V is a set of edges, W: V→ [symbol] ⁺ is a function that maps each vertex to a positive value representing the information weight of the corresponding vertex and P:E→(0, 1] is a function that maps each edge to its corresponding probability of existing in G. In the following it is assumed that the existence of different edges are independent from one another. Let us note, that our approach also applies to other models such as a conditional probability model, as long as a computational method for an unbiased drawing of samples of the probabilistic graph is available. For a conditional probability model reference is made to “M. Potamias, F. Bonchi, A. Gionis, and G. Kollios. k-nearest neighbors in uncertain graphs. PVLDB, 3(1):997-1008, 2010”.

In a probabilistic graph G, the existence of each edge is a random variable. Thus, the topology of G is a random variable, too. The sample space of this random variable is the set of all possible graphs. A possible graph g=(V_{g}, E_{g}) of a probabilistic graph G is a deterministic graph which is a possible outcome of the random variables representing the edges of G. The graph g contains a subset of edges of G, i.e., E_{g} ⊆E. The total number of such possible graphs is 2^{|E<1|}, where |E<1| represents the number of edges e∈E having P (e)<1, because for each such edge, we have two cases as to whether or not that edge is present in the graph. We let W denote the set of all possible graphs. The probability of sampling the graph g from the random variables representing the probabilistic graph G is given by the following sampling or realization probability Pr(g):

$$Pr ( g ) = {\prod }_{e ∈ Eg} P ( e ) \cdot {\prod }_{e ∈ E \text{/} {E}_{g}} ( 1 - P ( e ) ) . \qquad ( 1 )$$

FIG. 1 shows an example of a probabilistic graph G and its possible realization g1 in FIG. 4. This probabilistic graph has 2¹⁰=1024 possible worlds. Using Equation 1, the probability of world g1 is given by:

Pr(g1)=0.6*0.5*0.8*0.4*0.4*0.5*(1−0.1)*(1−0.3)*(1−0.4)*(1−0.1)=0.00653184.

Definition 1 (Path):

Let G=(V, E, W, P) be a probabilistic graph and let va, vb∈V be two nodes such that va≠vb. An (acyclic) path(va, vb)=va, v1, v2, . . . , vb be a sequence of vertices, such that ∀vi ∈path(va, vb): (vi∈V) and ∀vi, vj∈path(va, vb): vi≠vj.

Definition 2 (Reachability):

The network reachability problem as defined in “Jin, L. Liu, and C. C. Aggarwal. Discovering highly reliable subgraphs in uncertain graphs. In SIGKDD, pages 992-1000, 2011” and in “M. Kasari, H. Toivonen, and P. Hintsanen. Fast discovery of reliable k-terminal subgraphs. In M. J. Zaki, J. X. Yu, B. Ravindran, and V. Pudi, editors, PAKDD, volume 6119, pages 168-177, 2010” computes the likelihood of the binomial random variable [symbol] (i, j, G) of two nodes i, j∈V being connected in G, formally:

$$P ( ( i , j , G ) ) := {\sum }_{g ∈ W} {\prod }_{e ∈ Eg} P ( e ) \cdot {\prod }_{e ∈ E \text{/} {E}_{g}} ( 1 - P ( e ) ) \cdot ( i , j , g ) ,$$

where [symbol] (i, j, g) is an indicator function that returns one if there exists a path between nodes i and j in the (deterministic) possible graph g, and zero otherwise. For a given query node Q, our aim is to optimize the information gain, which is defined as the total weight of nodes reachable from Q.

Definition 3 (Expected Information Flow):

Let Q∈V be a node and let G=(V, E, W, P) be a probabilistic graph, then flow(Q, G) denotes the random variable of the sum of vertex weights of all nodes in V reachable from Q, formally:

$$flow ( Q , G ) := {\sum }_{v ∈ V} P ( ( Q , v , G ) ) \cdot W ( v ) .$$

Due to linearity of expectations, and exploiting that W (v) is deterministic, we can compute the expectation E(flow(Q, G)) of this random variable as

$$E ( flow ( Q , G ) ) = E ( ( {\sum }_{v ∈ V} ( Q , v , G ) ) \cdot W ( v ) ) = {\sum }_{v ∈ V} E ( ( Q , v , G ) ) \cdot W ( v ) . \\ \text{-} referred to as \qquad Equation ( 2 )$$

Given the definition of Expected Information Flow in Equation 2, we can now state the formal problem definition of optimizing the expected information flow of a probabilistic graph G for a constrained budget of edges.

Definition 4 (Maximum Expected Information Flow):

Let G=(V, E, W, P) be a probabilistic graph, let Q∈V be a query node and let k be a non-negative integer. The maximum expected information flow

MaxFlow(G,Q,k)=arg max_{G=(V,E′,⊆E,W,p),|E′|≤k}E(flow(Q,G)),
referred to as Equation(3);

is the subgraph of G maximizing the information flow Q constrained to having at most k edges.

Computing MaxFlow(G, Q, k) efficiently requires to overcome two np-hard subproblems. First, the computation of the expected information flow E(flow(Q, G)) to vertex Q for a given probabilistic graph G is np-hard. In addition, the problem of selecting the optimal set of k vertices to maximize the information flow MaxFlow(G, Q, k) is a np-hard problem in itself, as shown in the following.

Theorem 1: Even if the expected information flow(Q, G) to a vertex Q can be computed in O(1) for any probabilistic graph G, the problem of finding MaxFlow(G, Q, k) is still np-hard.

### Roadmap

To compute MaxFlow(G, Q, k), we first need an efficient solution to approximate the reachability probability E( [symbol] (Q, v, G)) from Q to/from a single node v. This problem is shown to be # P-hard. Therefore, the following section, relating to the “Component Tree” presents an approximation technique which exploits stochastic independencies between branches of a spanning tree of sub-graph G rooted at Q. This technique allows to aggregate independent subgraphs of G efficiently, while exploiting a sampling solution for components of the graph MaxFlow(G, Q, k) that contains cycles.

Once we can efficiently approximate the flow E( [symbol] (Q, v, G)) from Q to each node v∈V, we next tackle the problem of efficiently finding a subgraph MaxEFlow(G, Q, k) that yields a near-optimal expected information flow given a budget of k edges in Section VII. Due to the theoretic result of Theorem 1, we propose heuristics to choose k edges from G. Finally, experimental results support our theoretical intuition that our solutions for the two aforementioned subproblems synergize: Our reachability probability estimation exploits tree-like shapes of the respective sub-graph G c G, whereas the optimal solution to optimize a probabilistic graph G favors tree-like structures to maximize the number of nodes having a non-zero probability to reach Q.

### Expected Flow Estimation

In this section it is described, how the expected information flow of a given subgraph G⊆G will be estimated according to a preferred embodiment of the invention. Following Equation 2, the reachability probability reach(Q, v, G) between Q and a node v can be used to compute the total expected information flow E(flow(Q, G)). This problem of computing the reachability probability between two nodes has been shown to be #P hard and sampling solutions have been proposed to approximate it. In this section, we will present our solution to identify subgraphs of G for which we can compute the information analytically and efficiently, such that expensive numeric sampling only has to be applied to small subgraphs. We first introduce the concept of Monte-Carlo sampling of a subgraph.

Traditional Monte-Carlo Sampling

Lemma 1: Let G=(V, E, W, P), be an uncertain graph and let S be a set of sample worlds drawn randomly and unbiased from the set W of possible graphs of G. Then the average information flow in samples in S

$$\frac{1}{\vert S \vert} {\sum }_{g ∈ S} flow ( Q , G ) = \frac{1}{\vert S \vert} \cdot {\sum }_{g ∈ S} {\sum }_{v} reach ( Q , v , g ) \cdot W ( v ) \qquad ( 4 )$$

is an unbiased estimator of the expected information flow E(flow(Q, G)), where reach(Q, v, g) is an indicator function that returns one if there exists a path between nodes Q and v in the (deterministic) sample graph g, and zero otherwise.

Naive sampling of the whole graph G has two clear disadvantages: First, this approach requires to compute reachability queries on a set of possibly large sampled graphs. Second, a rather large approximation error is incurred. We will approach these drawbacks by first describing how non-cyclic subgraphs, i.e. trees, can be processed in order to exactly and efficiently compute the information flow without sampling. For cyclic subgraphs we show how sampled information flows can be used to compute the information flow in the full graph.

Exploiting non-Cyclic Components

The main observation that will be exploited by the algorithm according to this embodiment of the invention is the following: if there exists only one possible path between two vertices, then we can compute their reachability probability efficiently.

Lemma 2: Let G=(V, E, W, P) be a probabilistic graph and let A, B∈V. If path(A, B)=(A=v1, v2, . . . , vk−1, vk=B) is the only path between A and B, i.e., there exists no other path p∈V×V×V*that satisfies Definition 1, then the reachability probability between A and B is equal to the edge-probability product of path(A, B), i.e.,

$$reach ( A , B ) = {\prod }_{i = 1}^{k - 1} P ( ( {e}_{i} , {e}_{i + 1} ) )$$

Next, we generalize Lemma 2 to whole subgraphs, such that a specified vertex Q in that subgraph has a unique path to all other vertices in the subgraph. To identify such subgraphs, we will use the notion of cyclic graphs, which defines a cycle in a non-directed graph as a path from one vertex to itself, which uses all other vertex and edge at most once. Using Lemma 2, we can now define the following theorem that we will exploit in the remainder of this description.

Theorem 2: Let G=(V, E, G) be a probabilistic graph, let Q∈V be a node. If G is non-cyclic, then E(flow(Q, G)) can be computed efficiently.

Thus, a non-cyclic graph is defined by a graph where each vertex has exactly one path to the root. We aim to identify subgraphs of G that violate the non-cyclic structure and treat these subgraphs independently. Intuitively, such non-tree nodes have two “father” nodes both leading to the root.

Definition 5 (Cyclic Vertex):

A vertex vᵢ∈G is part of a cyclic subgraph containing Q if vᵢ has at least two neighbors vⱼ, vₖ such that there exists a path path(vⱼ, Q) and a path path(vₖ, Q), such that vᵢ∈path(vₖ, Q). We call such a vertex vᵢ a cyclic vertex, since vᵢ is involved in circular path path(Q, vⱼ), (vⱼ, vₖ), path(vₖ, Q) from the root Q to itself.

The information flowing from a cyclic vertex vᵢ can not be computed using Theorem 2, as there exists more than one path to Q. But we can estimate the flow using the sampling and exploiting Lemma 1. In the next section, relating to the “component tree” we propose an index structure, which can be used to identify the minimum subgraph that needs to be sampled, while maximizing the subgraph for which we can apply the analytic solution of Lemma 2.

### Component Tree

In this section we describe a novel approach of partitioning a graph into independent components, which we index using a novel (component tree based) index structure called Component Tree. Instead of sampling the whole uncertain graph, the purpose of this index structure is to exploit Theorem 2 for acyclic components, and to apply local Monte-Carlo within cyclic components only. Before we show how to utilize a Component Tree for efficient information flow computation, we first give a formal definition as follows.

Definition 6 (Component Tree):

Let G=(V, E, W, P) be a probabilistic graph and let Q∈V be a vertex for which the expected information flow is to be computed. A component tree CT is a tree structure, defined as follows.
1) each node of CT is a component. A component can be either a cyclic component or a non-cyclic component.
2) a non-cyclic component NC=(NC.V⊆V, NC.hub∈V) is a set of vertices NC.V ∪ NC.hub that form a non-cyclic subgraph in G. One of these nodes is labelled as hub node NC.hub.
3) a cyclic component C=(C.V, C.P (v), C.hub) is a set of vertices C.V U C.hub that form a cyclic subgraph in G. The function C.P (v): V_{CC}→[0, 1] maps each vertex v E C.V to the reachability probability reach(v, hub) of v being connected to hub in G.
4) Each edge in CT is labelled with a probability.
5) For each pair of (cyclic or non-cyclic) components (C1, C2), it holds that the intersection C1.V∩C2.V=ø of vertices is empty. Thus, each vertex in V is in at most one component vertex set.
6) Two different components may have the same hub vertex, and the hub vertex of one component may be in the vertex set of another component.
7) The hub vertex of the root of CT is Q.

Intuitively speaking, a component is a set of vertices together with a hub vertex that all information must flow through in order to reach Q. Each set of vertices is guaranteed to have such a hub vertex, but it might be Q itself. The idea of the component tree, is to use components as virtual vertices, such that all vertices of a component send their information to their hub, then the hub forwards all information to the next component, until the root of the component tree is reached where all information is send to hub vertex Q.

Example 6.1: As an example for a Component Tree, consider FIG. 5, showing a probabilistic graph with omitted edge probabilities. The task is to efficiently approximate the information flow to vertex Q. A non-cyclic component is given by A=({1, 2, 3, 6}, Q). For this component, we can exploit Theorem 2 to analytically compute the flow of information from any node in {1, 2, 3, 6} to hub Q. A cyclic-component is defined by B=({4, 5}, 3), representing a sub-graph having a cycle. Having a cycle, we cannot exploit Theorem 2 to compute the flow of a vertex in {4, 5} to vertex 3. But we can sample the subgraph spanned by vertices in {3, 4, 5} to estimate the expected flow of information to vertex 3. Given this expected flow, we can use the non-cyclic component A to analytically compute the expected information that is further propagated from the hub vertex 3 of component B to the hub vertex of A which is Q. Thus, component B is the child component of A in the Component Tree shown in FIG. 6 since B propagates its information to A. Another cyclic component is C=({7, 8, 9}, 6), for which we can estimate the information flow from vertices 7, 8, and 9 to hub 6 numerically using Monte-Carlo sampling. Since vertex 6 is in A, component C is a child of A. We find another cyclic component D=({10, 11}, 9), and two more non-cyclic components E=({13, . . . , 16}, 9) and F=({12}, 11).

In this example, the structure of the Component Tree allows us to compute or approximate the expected information flow to Q from each vertex. For this purpose, only two components need to be sampled. In the following, we show how a Component Tree can be maintained in the case where new edges are inserted. This allows to update the expected information flow to Q after each insertion. Exploiting that the graph that contains only one component (ø, Q) is a trivial component tree, we can construct a component tree for any subgraph using structural induction.

In the section “Optimal Edge selection” below, we will show how to choose promising edges to be inserted to maximize the expected information flow.

Updating a CT Representation

Given a Component Tree CT, this section shows how to update CT given a insertion of a new edge c=(v_{src}, v_{dest}) into G. Following Definition 6 of a Component Tree, each vertex v∈G is assigned to either a single non-cyclic component (noted by a flag v.isNC), a single cyclic component (noted by v.isCC), or to no component, and thus disconnected from Q, noted by v.isNew. Our edge-insertion algorithm derived in this section differs between these cases as follows:

Case I) v_{src}.isNew and v_{dest}.isNew: We omit this case, as our edge selection algorithms presented in the section “Optimal Edge selection” below, always ensures a single connected component, and initially the Component Tree containing only vertex Q.

Case II) v_{src}.isNew exclusive-or v_{dest}.isNew: Due to considering non-directed edges, we assume without loss of generality that v_{dest}.isNew. Thus v_{src} is already connected to component tree CT.

Case IIa): v_{src}.isNC: In this case, a new dead end is added to the non-cyclic structure NC_{src} which is guaranteed to remain non-cyclic. We add v_{dest} to NC_{src}.V.

Case IIb): v_{src}.isCC: In this case, a new dead end is added to the cyclic structure CC_{src}. This dead end becomes a new non-cyclic component NC=({v_{dest}}, v_{src}). Intuitively speaking, we know that node v_{dest} has no other choice but propagating its information to v_{src}. Thus, v_{src} becomes the hubvertex of v_{dest}. The cyclic component CC_{src} adds the new non-cyclic component NC to its list of children.

Case III) v_{src} and v_{dest} belong to the same component.

Case IIIa) This component is a cyclic component CC: Adding a new edge between v_{src} and v_{dest} within component CC may change the reachability CC.P (v) of each node v∈CC.V to reach their hub CC.hub. Therefore, CC needs to be re-sampled to numerically estimate the reachability probability function P (v) for each v∈CC.v.

Case IIIb): This component is a non-cyclic component NC: In this case, a new cycle is created within a non-cyclic component. We need to
(i) identify the set of vertices affected by this cycle,
(ii) split these vertices into a new cyclic component, and
(iii) handle the set of vertices that have been disconnected from NC by the new cycle.

These three steps are performed by the splitTree(NC, v_{src}, v_{dest}) function as follows:
(i) We start by identifying the new cycle as follows: Compare the (unique) paths of v_{src} and V_{dest} to NC.hub, and find the first vertex v_{Λ} that appears in both paths. Now we know that the new cycle is path(v_{Λ}, v_{src}), path(v_{dest}, V_{Λ}).
(ii) All of these vertices are added to a new cyclic component CC=(path(v_{Λ}, v_{src})∪path(v_{dest}, v_{Λ})\v_{Λ}, P (v), V_{Λ}) using v_{Λ} as their hub vertex. All vertices in NC having v_{Λ} (except v_{Λ} itself) on their path are removed from NC. The probability mass function P (v) is estimated by sampling the subgraph of vertices in CC.V. The new cyclic component CC is added to the list of children of NC.
(iii) Finally, orphans of NC that have been split off from NC due to the creation of CC need to be collected into new non-cyclic components. Such orphans must have a vertex of the cycle CC on their path to NC.hub. We group all orphans by these vertices: For each vᵢ ∈CC.V, let orphan, denote the set of orphans separated by vᵢ (separated means vi being the first vertex in CC.V on the path to NC.hub). For each such group, we create a new noncyclic component NCᵢ=(orphanᵢ, vᵢ). All these new non-cyclic components become children of NC. If NC.V is now empty, thus all vertices of NC have been reassigned to other components, then NC is deleted.

Case IV) v_{src} and V_{dest} belong to different components C_{src} and C_{dest}. Since the component tree CT is a tree, we can identify the lowest common ancestor C_{anc} of C_{src} and C_{dest}. The insertion of edge (V_{src}, V_{dest}) has incurred a new cycle ◯ going from C_{anc} to C_{src}, then to C_{dest} via the new edge, and then back to C_{anc}. This cycle may cross cyclic and non-cyclic components, which all have to be adjusted to account for the new circle. We need to identify all vertices involved to create a new cyclic component for ◯, and we need to identify which parts remain non-cyclic. In the following cases, we adjust all components involved in ◯ iteratively. First, we initialize ◯=(ø, P, v_{anc}), where v_{anc} is the vertex within C_{anc} where the circle meets if C_{anc} is a non-cyclic component, and C_{anc}.hub otherwise. Let C denote the component that is currently adjusted:

Case IVa) C=C_{anc}: In this case, the new circle may enter C_{anc} from two different hub vertices within Canc. In this case, we apply Case III, treating these two vertices as v_{src} and v_{dest}, as these two vertices have become connected transitively via the big cycle ◯.

Case IVb) C is a cyclic component: In this case C becomes absorbed by the new cyclic component ◯, thus ◯.V∪◯.V U C.v, and ◯ inherits all children from C. The rational of this step is that all vertices within C are able to access the new cycle.

Case IVc) C is a non-cyclic component: In this case, one path in C from one vertex v to C.hub is now involved in a cycle. All vertices involved in this path are added to ◯.V and removed from C. The operation splitTree(C, v, C.hub) is called to create new non-cyclic components that have been split off from C and become connected to C via ◯.

Insertion Examples (with respect to FIGS. 7 to 14):

In the following, we use the graph of FIG. 5 and its corresponding Component-Tree representation of FIG. 6 to insert additional edges and to illustrate the interesting cases of the insertion algorithm of Section “Updating a CT representation” above.

FIGS. 7, 9, 11 and 13 show a graph G and FIGS. 8, 10, 12 and 14 depict the updated component tree CT after insertion of the edge (which was depicted in the figure before). In these figures the reference numerals for the graph G and for the component tree CT were omitted, because of better readability.

We start by an example for Case II in FIG. 7. Here, we insert a new edge a=(8, 17), thus connecting a new vertex 17 to the component tree. Since vertex 8 belongs to the cyclic component C, we apply Case IIb. A new non-cyclic component G=({17}, 8) is created, and added to the children of C. FIG. 8 shows the updated component tree CT after insertion of edge a.

In FIG. 9, we insert a new edge b=(7, 9) instead. In this case, the two connected vertices are already part of the component tree, thus Case II does not apply. We find that both vertices belong to the same component C. Thus, Case III is used and more specifically, since component C is a cyclic component, Case IIIa is applied. In this case, no components need to be changed, but the probability function C.P (v) has to re-approximated, as the probabilities of nodes 6, 7 and 8 will have increased probability of being connected to hub vertex 6, due to the existence of new paths leading via edge b. FIG. 10 shows the updated component tree CT after insertion of edge b.

Next, in FIG. 11, an edge c is inserted between vertices 14 and 15. Both vertices belong to the non-cyclic component E, thus Case IIIb is applied here. After insertion of c, the previously non-cyclic component E=({13, 14, 15, 16}, 9) now contains a cycle involving vertices 13, 14 and 15. (i) We identify this cycle by considering the previous paths from vertices 14 and 15 to their hub vertex 9. These paths are (14, 13, 9) and (15, 13, 9), respectively. The first common vertex on this path is 13, thus identifying the new cycle. (ii) We create a new cyclic component G=({14, 15}, 13), containing all vertices of this cycle using the first common vertex 13 as hub vertex. We further remove these vertices except the hub vertex 13 from the non-cyclic component E; the probability function G.P (v) is initialized by sampling the reachability probabilities within G; and G is added to the list of children of E. (iii) Finally, orphans need to be collected. These are nodes that previously had nodes vertices in G.V, which have now become cyclic, on their (previously unique) path to their former hub 9. Not a single orphan has vertex 14 on its path to 9, such that no new non-cyclic component is created for vertex 14. However, we find that one vertex, vertex 16, had 15 as the first removed vertex on its path to 9. Thus, vertex 16 is moved from component E into a new non-cyclic component H=({16}, 15), terminating this case. Summarizing, vertex 16 in component H now reports its information flow to vertex 15 in component G, for which the information flow to vertex 9 in component E is approximated using Monte-Carlo sampling, this information is then propagated analytically to vertex 9 in component C, subsequently, the remaining flow that has been propagated all this way, is approximatively propagated to vertex 6 in component A, which allows to analytically compute the flow to vertex Q. FIG. 12 shows the updated component tree CT after insertion of edge c.

For the last case, Case IV, consider FIG. 13, where a new edge d=(11; 15) connected two vertices belonging to two different components D and E. We start by identifying the cycle that has been created within the component tree, involving components D and E, and meeting at the first common ancestor component C. For each of these components in the cycle (D, C, E), one of the subcases of Case IV is used. For component C, we have that C=C_{anc} is the common ancestor component, thus triggering Case IVa. We find that both components D and E used vertex 9 as their hub vertex v_{anc}. Thus, the only cycle incurred in component C is the (trivial) cycle (9) from vertex 9 to itself, which does not require any action. We initialize the new cyclic component ◯=(ø, ⊥, 9), which initially holds no vertices, and has no probability mass function computed yet (the operator ⊥ can be read as null or not-defined) and uses v_{anc}=9 as hub. For component D, we apply Case IVb, as D is a cyclic component, it becomes absorbed by a new cyclic component ◯, now having ◯=({10, 11}, ⊥, 9). For the non-cyclic component E Case IVc is used. We identify the path within E that is now involved in a cycle, by using the path (15, 13, 9) between the involved vertex 15 to hub vertex 9. All nodes on this path are added to ◯, now having ◯=({10, 11, 15, 13}, ⊥, 9). Using the splitTree operation similar to Case III, we collect orphans into new non-cyclic components, creating G=({14}, 13) and H=({16}, 15) as children of ◯. Finally, Monte-Carlo sampling is used to approximate the probability mass function ◯.P(v) for each v∈◯.V. FIG. 14 shows the updated component tree CT after insertion of edge d.

### Optimal Edge Selection

The previous section presented the Component Tree, a data structure to compute the expected information flow in a probabilistic graph. Based on this structure, heuristics to find a near-optimal set of k edges to maximize the information flow MaxEFlow(G, Q, k) to a vertex Q (see Definition 4) are presented in this section. Therefore, we first present a Greedy heuristic to iteratively add the locally most promising edges to the current result. Based on this Greedy approach, we present improvements, aiming at minimizing the processing cost while maximizing the expected information flow.

### Greedy Algorithm

Aiming to select edges incrementally, the Greedy algorithm initially uses the probabilistic graph G₀=(V; E₀=ØP), which contains no edges. In each iteration i, a set of candidate edges “candList” is maintained, which contains all edges that are connected to Q in the current graph Gᵢ, but which are not already selected in Eᵢ. Then, each iteration selects an edge e the addition of which maximizes the information flow to Q, such that Gᵢ₊₁=(V, Eᵢ∩e, P), where

$$e = argmax E ( flow ( Q , ( V , {E}_{i} ⋂ e , P ) ) ) . \\ e ∈ candList \qquad ( 5 )$$

For this purpose, each edge e E candList is probed, by inserting it into the current Component Tree CT using the insertion method presented in the Section, relating to the Component tree above. Then, the gain in information flow incurred by this insertion is estimated. After k iterations, the graph Gₖ=(V, Ek, P) is returned.

### Component Memorization

We introduce an optimization reducing the number of cyclic components for which their reachability probabilities have to be estimated using Monte-Carlo sampling, by exploiting stochastic independence between different components in the Component Tree CT. During each Greedy-iteration, a whole set of edges candList is probed for insertion. Some of these insertions may yield new cycles in the Component Tree, resulting from Cases IIIa, IIIb, and IV. Using component memorization, the algorithm memorizes, for each edge e in candList, the probability mass function of any cyclic component CC that had to be sampled during the last probing of e. Should e again be inserted in a later iteration, the algorithm checks if the component has changed, in terms of vertices within that component or in terms of other edges that have been inserted into that component. If the component has remained unchanged, the sampling step is skipped, using the memorized estimated probability mass function instead.

### Sampling Confidence Intervals

A Monte-Carlo Sampling is controlled by a parameter Samplesize which corresponds to the number of samples taken to approximate the information flow of a cyclic component to its hub vertex. In each iteration, we can reduce the amount of samples by introducing confidence interval for the information flow for each edge e∈candList that is probed. The idea is to prune the sampling of any probed edge e for which we can conclude that, at a sufficiently large level of significance □, there must exist another edge e′≠e in candList such that e′ is guaranteed to have a higher information flow that e, based on the current number of samples only. To generate these confidence intervals, we recall that, following Equation 4 the expected information flow to Q is the sample-average of the sum of information flow of each individual vertex. For each vertex v, the random event of being connected to Q in a random possible follows a binomial distribution, with an unknown success probability p. To estimate p, given a number S of samples and a number 0≤s≤S of ‘successful’ samples in which Q is reachable from v, we borrow techniques from statistics to obtain a two sided 1-□□ confidence interval of the true probability p. A simple way of obtaining such confidence interval is by applying the Central Limit Theorem of Statistics to approximate a binomial distribution by a normal distribution.

Definition 7 (□-Significant Confidence Interval):

Let S be a set of possible graphs drawn from the probabilistic graph G, and let be

$$\hat{p} := \frac{s}{S}$$

the fraction of possible graphs in S in which Q is reachable from v. With a likelihood of 1-□, the true probability E( [symbol] (Q, v, G)) that Q is reachable from v in the probabilistic graph G is in the interval

p±z·\sqrt{\hat{p}(1−\hat{p})}, (6)

where z is the 100_(1−0.5·□) percentile of the standard normal distribution. We denote the lower bound as E_{lb}( [symbol] (Q, v, G)) and the upper bound as E_{ub}( [symbol] (Q, v, G)). We use □=0.05.

To obtain a lower bound of the expected information flow to Q in a graph G, we use the sum of lower bound flows of each vertex using Equation 4 to obtain

$${E}_{lb} ( flow ( Q , G ) ) = {\sum }_{v ∈ V} {E}_{lb} ( ( Q , v , G ) ) \cdot W ( v )$$

as well as the upper bound

$${E}_{ub} ( flow ( Q , G ) ) = {\sum }_{v ∈ V} {E}_{ub} ( ( Q , v , G ) ) \cdot W ( v )$$

Now, at any iteration i of the Greedy algorithm, for any candidate edge e′ ∈ candList having an information flow lower bounded by lb:=E_{lb}(flow(Q, Gᵢ)∩e), we prune any other candidate edge e′∈candList having an upper bound ub:=E_{Ub}(flow(Q, Gᵢ∩e′)) if lb>ub. The rational of this pruning is that, with a confidence of 1−□, we can guarantee that inserting e′ yields less information gain than inserting e. To ensure that the Central Limit Theorem is applicable, we only apply this pruning step if at least 30 sample worlds have been drawn for both probabilistic graphs.

### Delayed Sampling

For the last heuristic, we reduce the number of Monte-Carlo samplings that need to be performed in each iteration of the Greedy Algorithm, described above. In a nutshell, the idea is that an edge, which yields a much lower information gain than the chosen edge, is unlikely to become the edge having the highest information gain in the next iteration. For this purpose, we introduce a delayed sampling heuristic. In any iteration I of the Greedy Algorithm, let e denote the best selected edge, as defined in Equation 5. For any other edge e′ ∈candList, we define its potential

$$pot ( {e}^{′} ) := \frac{E ( flow ( Q , ( V , {E}_{i} ⋂ {e}^{′} , P ) )}{E ( flow ( Q , ( V , {E}_{i} ⋂ e , P ) )} ,$$

as the fraction of information gained by adding edge e′ compared to the best edge e which has been selected in an iteration. Furthermore, we define the cost cost(e′) as the number of edges that need to be sampled to estimate the information gain incurred by adding edge e′. If the insertion of e′ does not incur any new cycles, then cost(e′) is zero. Now, after iteration i where edge e′ has been probed but not selected, we define a sampling delay

$$d ( {e}^{′} ) = ⌊ {log}_{c} \frac{cost ( {e}^{′} )}{pot ( {e}^{′} )} ⌋$$

which implies that e′ will not be considered as a candidate in the next d iterations of the Greedy algorithm, described in the above Section. This definition of delay, makes the (false) assumption that the information gain of an edge can only increase by a factor of c≥1 in each iteration, where the parameter c is a used to control the penalty of having high sampling cost and having low information gain. As an example, assume an edge e0 having an information gain of only 1% of the selected best edge e, and requiring to sample a new cyclic component involving 10 edges upon probing. Also, we assume that the information gain per iteration (and thus by insertion of other edges in the graph), may only increase by a factor of at most c=2. We get

$$d ( {e}^{′} ) = ⌊ {log}_{2} \frac{10}{0.01} ⌋ = ⌊ {log}_{2} 1000 ⌋ = 9.$$

Thus, using delayed sampling and having c=2, edge e′ would not be considered in the next nine iterations of the edge selection algorithm. It must be noted that this delayed sampling strategy is a heuristic only, and that no correct upper-bound c for the change in information gain can be given. Consequently, the delayed sampling heuristic may cause the edge having the highest information gain to not be selected, as it might still be suspended. Our experiments show that even for low values of c (i.e., close to 1), where edges are suspended for a large number of iterations, the loss in information gain is fairly low.

### Evaluation

This section evaluates efficiency and effectiveness of our proposed solutions to compute a near-optimal subgraph of an uncertain graph which maximizes the information flow to a source node Q, given a constrained number of edges, according to Definition 4. As motivated above in the general description, one main application field of information propagation on uncertain graphs is: i) information/data propagation in spatial networks, such as wireless networks or a road networks. Moreover, a second application may be for ii) information/belief propagation in social networks. These two types of uncertain graphs have extremely different characteristics, which require separate evaluation. A spatial network follows a locality assumption, constraining the set of pairwise reachable nodes to a spatial distance. Thus, the average shortest path between a pair two randomly selected nodes can be very large, depending on the spatial distance. In contrast, a social network has no locality assumption, thus allowing moving through the network with very few hops. As a result, without any locality assumption, the set of nodes reachable in k-hops from a query node may grow exponentially large in the number of hops. In networks following a locality assumption, this number grows polynomial, usually quadratic (in sensor and road networks on the plane) in the range k, as the area covered by a circle is quadratic to its radius. Our experiments have shown, that the locality assumption, which clearly exists in some applications but not in others, has tremendous impact on the performance of our algorithms, including the baseline. Consequently, we evaluate both cases separately. Beside these two cases we also evaluate the following parameters, with default values specified as follows: size of the Graph |V|=10,000, average vertex degree d=2, and the budget of edges k=100.

All experiments were evaluated on a system with Windows 10, 64 Bit, 16.0 GB RAM with the processor unit Intel® Xeon® CPU E3-1220, 3.10 Ghz. All algorithms were implemented in Java (version 1.8.0_91).

### Evaluated Algorithms

The algorithms that we evaluate in this section are denoted and described as follows:

Naive

As proposed elsewhere the first competitor Naïve does not utilize the independent component strategy of the Section relating to the “expected Flow Estimation” and utilizes a pure sampling approach to estimate reachability probabilities. To select edges, the greedy approach chooses the locally best edge as shown in the Section “Optimal Edge Selection” but does not use the Component Tree representation presented in the Component Tree Section. We use a constant Monte-Carlo sampling size of 5000 samples.

Dijkstra

Shortest-path spanning trees, as described in “K. Sohrabi, J. Gao, V. Ailawadhi, and G. J. Pottie. Protocols for self-organization of a wireless sensor network. IEEE personal communications, 7(5):16-27, 2000” are used to interconnect a wireless sensor network to a sink node. To obtain a maximum probability spanning tree, we proceed as follows: the probability P(e) of each edge e∈E is set to P′(−log(P(e)). Running the traditional Dijkstra algorithm on the transformed graph starting at node Q yields, in each iteration, a spanning tree which maximizes the connectivity probability between Q and any node connected to Q [32]. Since, in each iteration, the resulting graph has a tree structure, this approach can fully exploit the concept of Section V, requiring no sampling step at all.

CT employs the component tree proposed in the section, relating to the “expected Flow Estimation” for deriving the reachability probabilities. To sample cyclic components, we draw 5000 samples for a fair comparison to Naive. All following CT-Algorithms build on top of CT.

According to a preferred embodiment the basic CT algorithm may be extended with the memorization algorithm. Thus, CT+M additionally maintains for each candidate edge e a pdf (as a measure of information flow) of the corresponding cyclic component from the last iteration (cf Section “Component Memorization”).

According to another preferred embodiment the basic CT algorithm may be extended with the sampling of confidence intervals. Thus, CT+M+CI ensures that probing of an edge is stopped whenever another edge has a higher information flow with a certain degree of confidence as explained in Section “Sampling Confidence Intervals”.

According to another preferred embodiment the basic CT algorithm may be extended with a delayed sampling. Thus, CT+M+DS tries to minimize the candidate edges in an iteration by leafing out edges that had a small information gain-cost—ratio in the last iteration (cf Section “Delayed Sampling”). Per default, we set the penalization parameter to c=2.

CT+M+CI+DS Combines all of the above concepts. Other embodiments refer to other combinations of the algorithms and extensions, mentioned above.

FIG. 15 depicts a flow chart, representing a possible workflow of the method according to a preferred embodiment of the present invention. The method for example may be implemented as algorithm in Java on a general purpose computer and may be executed on one network node of the technical network NW. It may also be executed in a distributed fashion on a plurality of network nodes.

After Start of the method, in step 1 the technical network constraints or the network budget is determined. The restricted network budget may refer to the usability of certain network nodes and the corresponding costs, involved with the activation of the respective network link to the node. The constraints may be based on restricted availability of the network node (bandwidth restriction) or may be due to restricted resources. The constraints may be measured or may be read in via an input interface II. In addition, it is possible to determine runtime requirements (for example based on a user input).

In step 2 the network NW is represented in a probabilistic graph with nodes and edges and by consideration of network constraints.

The technical network NW is decomposed into independent components in step 3 and in step 4 the component tree data structure CT is generated.

In step 5 a list of candidate edges to be potentially added iteratively to the component tree CT is generated.

In step 6 the expected information flow for each of the candidate edges is iteratively computed, in order to select that candidate edge for insertion in (update of) the component tree CT, for which the expected information flow is maximized. Here, in step 7, in a preferred embodiment the runtime requirements are processed. Depending on the runtime requirements an optimal edge selection algorithm is selected and applied. In general, in case the runtime requirements are detected as being low, the basic algorithm, described above (CT algorithm) may be applied. In case of higher runtime requirements are detected, the optimization algorithms for the basic optimal edge selection algorithm, described above (CT+M, CT+M+CI, CT+M+DS, CT+M+CI+DS) are applied. The selection and execution of the optimization algorithm is executed in the optimizer, shown in FIG. 16, below.

At the end of each iteration step the component tree CT data structure—which may be stored in a memory MEM—is updated in step 8 with the selected edge, i.e. with the edge, which has been selected as being optimal with respect to the information flow, which means, where the information flow may be maximized. Step 8 represents the iteration over steps 5 to 7 for probing candidate edge for insertion in the component tree CT and after having selected the best edge for updating the component tree CT.

After having provided a set of edges, at the END a result r is calculated automatically, which specifies those network nodes for data propagation for which the information will be maximized. Simultaneous to the iteration and during this calculation the runtime for providing the result r is optimized. In particular, the determined runtime requirements are processed for the selection of the optimal edge selection algorithm in step 7. Dependent on the determined runtime requirements the corresponding heuristics are applied by an optimizer 200, as described below. After this, the method will end.

The component tree CT serves as a basis for the CT algorithm according to the embodiment of the invention. The components are organized and indexed in a CT-specific manner. Thus, in each step of the iteration one edge is activated. The affiliation of an edge to a component is unique at each point in time. In each iteration, the CT tree is only augmented by one edge. The question of which edge to select in an iteration is handled by computing the information gain of each candidate edge. The algorithm selects that edge which is the most promising edge with respect to information flow to or from a designated source node Q in the network NW. The algorithms use the component tree CT representation in order to compute the information gain of a candidate edge only by considering components being affected, when the candidate edge would be included in the spanning graph or CT tree.

The algorithms presented above (CT, CT with memorization M, and additionally with confidence interval CI sampling and additionally with delayed sampling DS) use different heuristics for adapting the time to determine the result r with the communication path which should be used for information flow maximization.

FIG. 16 shows a block diagram of a control node 10, which is adapted for controlling data or information propagation in the network NW. The control node 10 may itself be part of the technical network NW. The network NW as such and its technical constraints and optionally runtime requirements determined and/or are forwarded to the control node 10 via the input interface II. The control node 10 comprises a processor 100. The processor 100 is adapted for generating a probabilistic graph G for the technical network NW. Alternatively, the probabilistic graph G may be generated elsewhere and is imported via input interface II. An edge in the graph G is assigned with a probability value, representing a respective technical network constraint for activating said edge in the technical network NW. The processor 100 is further adapted for providing or calculating the probabilistic graph G and for decomposing the probabilistic graph G into independent components and for generating a component tree structure CT as data structure. The memory MEM stores the component tree CT and its updates. Additionally, the graph G and the candidate list of candidate edges may also be stored in the memory MEM. The processor 100 is further adapted to iteratively determine an optimal edge in the generated component tree CT, which maximizes an expected information flow to a query node Q to and/or from each node by processing the determined technical network constraints and by
Executing a Monte-Carlo sampling for estimation of the expected information flow for cyclic components in the component tree CT and
Computing the expected information flow of the non-cyclic components in the component tree CT analytically.

The processor 100 is adapted to update the component tree CT iteratively with each determined optimal edge and to re-estimate the expected information flow in the updated component tree and to calculate an optimal set of edges and based thereon. The result r is provided via an output interface OI. As depicted in FIG. 16, the result r may serve for controlling the network operation. The result r may be fed to a central control unit for operating the network NW so that information flow is maximized and runtime requirements are also met. The result r may consist of a list of network nodes, which should be involved for data propagation.

As can be seen in FIG. 16, the control node 10 may also comprise an optimizer 200.

The optimizer 200 is adapted to select an optimal edge selection algorithm in dependence on the determined runtime requirements. The runtime requirements may be specified by a user (e.g. a network administrator) in a configuration phase. The optimizer 200 is adapted to execute an optimization, reducing the computations in each iteration. In each iteration the information flow of each component tree CT representation has to be computed. According to the CT algorithm, described above, it is possible to calculate the information flow only once, if the same components of the CT representation are affected by a candidate in consecutive iterations. This has a major performance advantage.

Finally, in the detailed description above implementations and solutions for the problem of maximizing information flow in an uncertain graph given a fixed budget of k communication edges have been described. We identified two np-hard subproblems that needed heuristical solutions:

(i) Computing the expected information flow of a given subgraph, and

(ii) selecting the optimal k-set of edges.

For problem (i) we developed an advanced sampling strategy that only performs an expensive (and approximate) sampling step for parts of the graph for which we cannot obtain an efficient (and exact) analytic solution. For problem (ii) we propose our Component Tree representation of a graph G, which keeps track of cyclic components—for which sampling is required to estimate the information flow—and non-cyclic components—for which the information flow can be computed analytically. On the basis of the CT representation, we introduced further approaches and heuristics to handle the trade-off between effectiveness and efficiency. Our evaluation shows that these enhanced algorithms are able to find high quality solutions (i.e., k-sets of edges having a high information flow) in efficient time, especially in graphs following a locality assumption, such a road networks and wireless sensor networks.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for reliably optimizing data propagation in a technical network with a plurality of nodes and edges by processing technical network constraints for activating the edges in the technical network, wherein the technical network is represented as a probabilistic graph with edges and assigned probability values, the method comprising:
generating a component tree as data structure by partitioning the probabilistic graph into independent components, representing a subset of the probabilistic graph and comprising cyclic and non-cyclic components, wherein an edge in the component tree represents a parent-child relationship between the components:
iteratively determining an optimal edge in the generated component tree, which maximizes an expected information flow to a query node to and/or from each network node by processing the technical network constraints and by:
executing a Monte-Carlo sampling for estimation of the expected information flow for the cyclic components, and
computing the expected information flow of the non-cyclic components analytically;
updating the component tree iteratively with each determined optimal edge and re-estimating the expected information flow in the updated component tree; and
calculating an optimal set of edges and based thereon providing a result with nodes in the technical network for data propagation, so that information flow is maximized by processing technical network constraints.

2. The method according to claim 1, wherein iteratively determining the optimal edge is executed by applying a heuristic, exploiting features of the component tree.

3. The method according to claim 2, wherein the heuristic is based on a Greedy algorithm.

4. The method according to claim 1, wherein iteratively determining the optimal edge is optimized by component memorization:
skipping the step of executing a Monte-Carlo sampling for estimation of the expected information flow of the cyclic components which remained unchanged and by
memorizing and re-using calculated values of the information flow for the unchanged components.

5. The method according to claim 1, wherein the Monte-Carlo sampling is optimized by pruning the sampling and by sampling confidence intervals, so that probing an edge is stopped whenever another edge has a higher information flow with a certain degree of confidence.

6. The method according to claim 1, the Monte-Carlo sampling is optimized by application of a delayed sampling, which considers the costs for sampling a candidate edge in relation to its information gain in order to minimize the amount of candidate edges to be sampled.

7. The method according to claim 1, further comprising:
determining runtime requirements for providing the result,
so that the iterative determination of an optimal edge is executed by selecting an edge selection algorithm so that the determined runtime requirements are met.

8. The method according to claim 1, wherein the number of edges in the technical network, which can be activated, is limited due to the technical network constraints.

9. The method according to claim 1, wherein computing expected information flow of the non-cyclic components analytically is based on the following equation:
$$E ( ( {\sum }_{v ∈ V} ( Q , v , G ) ) \cdot W ( v ) ) = {\sum }_{v ∈ V} E ( ( Q , v , G ) ) \cdot W ( v ) ,$$
wherein G=(V, E, W, P) is a probabilistic directed graph, where V is a set of vertices v, E ⊆V×V is a set of edges, W: V→ [symbol] ⁺ is a function that maps each vertex to a positive value representing an information weight of the corresponding vertex and wherein Q∈V is a node.

10. The method according to claim 1, wherein determining an optimal edge is executed by selecting a locally most promising edge out of a set of candidate edges, for which the expected information flow can be maximized, wherein the estimation of the expected information flow for a candidate edge is executed only on those components of the component tree which are affected, if the candidate edge would be included in the component tree of the technical network.

11. The method according to claim 1, further comprising:
aggregating independent subgraphs of the probabilistic graph efficiently, while exploiting a sampling solution for components of the graph MaxFlow that contain cycles.

12. A control node in a technical network with a plurality of nodes and connections between the nodes, which is represented in a probabilistic graph, wherein an edge in the graph is assigned with a probability value, representing a respective technical network constraint for activating the edges in the technical network, wherein the control node comprises:
an input interface for determining technical network parameters and network constraints;
a processor which is adapted for providing a probabilistic graph for the technical network and for decomposing the probabilistic graph into independent components and for generating a component tree structure as data structure
a memory for storing that data structure;
wherein the processor is further adapted to iteratively determine an optimal edge in the generated component tree, which maximizes an expected information flow to a query node to and/or from each node by processing the determined technical network constraints and by:
executing a Monte-Carlo sampling for estimation of the expected information flow for cyclic components in the component tree, and
computing the expected information flow of the non-cyclic components in the component tree analytically
and wherein the processor is adapted to update the component tree iteratively with each determined optimal edge and to re-estimate the expected information flow in the updated component tree and to calculate an optimal set of edges and based thereon
wherein the control node further comprises an output interface for providing a result with nodes in the technical network for data propagation, so that information flow is maximized by processing technical network constraints.

13. The control node according to claim 12, wherein the control node further comprises an optimizer which is adapted to determine runtime requirements and to apply optimization algorithms for handling a tradeoff between effectiveness and efficiency of the processor for providing the result.

14. The control node according to claim 12 directed on the control node, wherein the control node is implemented on a sending node for sending data to a plurality of network nodes.

15. The control node according to claim 12 directed on the control node, wherein the control node is implemented on a receiving node for receiving data from a plurality of network nodes, comprising sensor nodes.

16. A computer network system for use in a technical network with a plurality of nodes and connections between the nodes, which is represented in a probabilistic graph, wherein an edge in the graph is assigned with a probability value, representing a respective technical network constraint for activating said edge in the network, comprising:
a control node, which is adapted to control the propagation of data in the technical network according to the method of claim 1.
